(19) United States
(12) Patent Application Publication
(10) Pub. No.: US 2024/0143274 A1
(43) Pub. Date: May 2, 2024

(54) NEURAL NETWORK OPERATION APPARATUS AND METHOD

(71) Applicants: SAMSUNG ELECTRONICS CO., LTD., SUWON-SI (KR); UNIST(ULSAN NATIONAL INSTITUTE OF SCIENCE AND TECHNOLOGY), Ulsan (KR)

(72) Inventors: Hyeonuk SIM, Suwon-si Gyeonggi-do (KR); Jongeun LEE, Ulsan (KR); Azat AZAMAT, Ulsan (KR)

(21) Appl. No.: 18/311,509

(22) Filed: May 3, 2023

(30) Foreign Application Priority Data
Oct. 28, 2022 (KR) 10-2022-0141649

(51) Int. Cl. G06F 5/01; G06F 7/499

(52) U.S. Cl. CPC G06F 5/01; G06F 7/49947

(57) ABSTRACT

A neural network operation apparatus and method are disclosed. A neural network operation apparatus includes a receiver that receives data for a neural network operation, and a processor that performs a scaling operation by multiplying the data by a constant, performs a rounding operation by truncating bits forming a result of the scaling operation, performs a scaling back operation based on a result of the rounding operation, and generates a neural network operation result by accumulating results of the scaling back operation.

### CROSS-REFERENCE TO RELATED APPLICATION

This application claims priority under 35 USC § 119(a) to Korean Patent Application No. 10-2022-0141649, filed on Oct. 28, 2022, in the Korean Intellectual Property Office, the disclosure of which is incorporated by reference herein in its entirety.

### BACKGROUND

The present disclosure relates to a neural network operation apparatus and method. There has been a growing interest in hardware design for neural networks. For example, some neural networks operate using processors that use one or more accumulators. An accumulator is a register in which intermediate arithmetic logic unit results are stored. However, accumulators for performing neural network operations may not be optimized for performing the operations of the neural network.

For example, a feedback interactive neural network (FINN) is a binarized neural network (BNN) based on a streaming structure. A FINN may have layers implemented with dedicated hardware, but its scalability may be limited when it is used in a large-scale network. In some cases, the performance of a neural network such as a FINN may be impacted by the size of an accumulator.

### SUMMARY

The Summary describes a selection of concepts that are further described below in the Detailed Description. The Summary is not intended to identify key features or essential features of the claimed subject matter, nor is it intended to be used as an aid in determining the scope of the claimed subject matter.

In one general aspect, a neural network operation apparatus includes a receiver configured to receive data for a neural network operation of a neural network, and a processor configured to determine a scaling constant based on a structure of the neural network, perform a scaling operation by multiplying the data by a constant, perform a rounding operation by truncating bits forming a result of the scaling operation, perform a scaling back operation based on a result of the rounding operation, and perform the neural network operation by accumulating results of the scaling back operation.

The processor may be configured to perform a clipping operation on the result of the rounding operation based on a predetermined precision range and perform the scaling back operation on a result of performing the clipping operation. The processor may be configured to calculate a partial sum based on the data and perform the scaling operation on the partial sum. The scaling operation and the scaling back operation may be performed by a bit shifter.

The processor may be configured to perform the scaling operation based on a scale factor, and the scale factor may be a power of two. The processor may be configured to determine the scale factor based on precision of an accumulator. The processor may be configured to perform the rounding operation by performing truncation based on a most significant bit of the result of the scaling operation. The processor may be configured to perform the rounding operation by inputting the most significant bit to an accumulator. The processor may include a multiplexer configured to perform a bit-selection operation that selects one of a first scale value and a second scale value based on a selection bit. The processor may be configured to determine the selection bit based on a type of a neural network.

In another general aspect, a neural network operation method includes receiving data for a neural network operation of a neural network, determining a scaling constant based on a structure of the neural network, performing a scaling operation by multiplying the data by the scaling constant, performing a rounding operation by truncating bits forming a result of the scaling operation, performing the scaling back operation based on a result of the rounding operation, and performing the neural network operation by accumulating results of the scaling back operation.

The performing the scaling back operation may include performing a clipping operation on the result of the rounding operation based on a predetermined precision range, and performing the scaling back operation on a result of performing the clipping operation. The performing the scaling operation may include calculating a partial sum based on the data, and performing the scaling operation on the partial sum. The scaling operation and the scaling back operation may be performed by a bit shifter. The performing the scaling operation may include performing the scaling operation based on a scale factor, and the scale factor may be a power of two. The performing the scaling operation may include determining the scale factor based on precision of an accumulator.

The performing the rounding operation may include performing the rounding operation by performing truncation based on a most significant bit of the result of the scaling operation. The performing the rounding operation by performing the truncation based on the most significant bit of the result of the scaling operation may include performing the rounding operation by inputting the most significant bit to an accumulator.

The neural network operation method may further include performing a bit-selection operation that involves selecting one of a first scale value and a second scale value based on a selection bit. The performing the bit-selection operation may include determining the selection bit based on a type of a neural network.

In some examples, the neural network operations can include performing multiple multiplication operations at nodes of a neural network, combining the results of the multiplication operations, and then performing a non-linear activation function on the result of combining the multiplication operations.

In another aspect, a method comprises identifying a structure of a neural network; determining a size of an accumulator based on the structure of the neural network; and performing a neural network operation for the neural network by performing a scaling operation based on the size of the accumulator.

Other features and aspects will be apparent from the following detailed description, the drawings, and the claims.

### BRIEF DESCRIPTION OF THE DRAWINGS

FIG. 1 illustrates an example of a neural network operation apparatus.

FIG. 2 illustrates an example of an implementation of a neural processing unit (NPU) structure.

FIG. 3A illustrates a change in area of a multiply and accumulation (MAC) array depending on a tile size.

FIG. 3B illustrates a change in power consumption of a MAC array depending on a tile size.

FIG. 4 illustrates an example of an implementation of an accumulator.

FIG. 5 illustrates an operation of a scaling accumulator including a rounding operation.

FIG. 6 illustrates a multiplexer for supporting a plurality of scale parameters.

FIG. 7 illustrates a comparison of areas according to whether there is a multiplexer.

FIG. 8 illustrates an example of a post-training quantization (PTQ) result.

FIG. 9 illustrates another example of a PTQ result.

FIG. 10 illustrates an example of precision of an accumulator when there is no scaler.

FIG. 11 illustrates an example of precision of an accumulator when there is a scaler.

FIG. 12 illustrates another example of precision of an accumulator when there is no scaler.

FIG. 13 illustrates another example of precision of an accumulator when there is a scaler.

FIG. 14 illustrates an example of an area and power consumption when the neural network operation apparatus of FIG. 1 is used.

FIG. 15 illustrates an example of partial sum operation precision according to accumulate operation precision.

FIG. 16 illustrates another example of partial sum operation precision according to accumulate operation precision.

FIG. 17 is a flowchart of an operation the neural network operation apparatus illustrated in FIG. 1.

FIG. 18 is a flowchart illustrating a method of performing a neural network operation.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed structural or functional description is provided as an example only and various alterations and modifications may be made to the examples. Accordingly, examples are not to be construed as limited to the disclosure and should be understood to include all changes, equivalents, and replacements within the idea and the technical scope of the disclosure.

Embodiments of the present disclosure relate to a neural network operation apparatus and method. In some embodiments, layer hyperparameters or other aspects of a neural network structure are used to optimize the size of an accumulator for a neural network operation. Accordingly, embodiments of the disclosure perform neural network operations using an accumulator that is scalable and has a size determined according to a neural network structure.

In some embodiments, a scaling operation is performed by multiplying data by a constant, truncating bits forming a result of the scaling operation, scaling back the result of the rounding operation, and generating a neural network operation result by accumulating results of the scaling back operation.

Embodiments of the present disclosure result in an improvement to a computer by providing a computing device that can perform neural network operations more efficiently. For example, a computing device may perform neural network operations by determining an efficient size for an accumulator and scaling the effective size of an accumulator by performing scaling, rounding, and scaling back operations before using the accumulator to perform the neural network operations. This can lead to a more efficient operation of the neural network that results in fewer computing operations as the size of the accumulator is not exceeded.

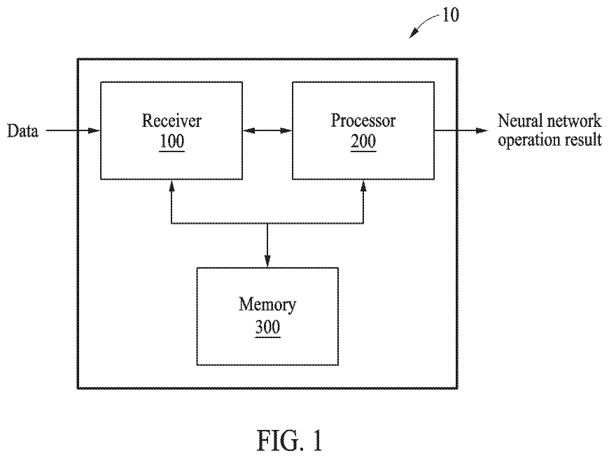

FIG. 1 illustrates an example of a neural network operation apparatus.

Referring to FIG. 1, a neural network operation apparatus 10 is configured to perform a neural network operation. For example, the neural network operation apparatus 10 may perform a multiply and accumulation (MAC) operation. Accordingly, the neural network operation apparatus 10 may perform an accumulate operation.

A neural network can be implemented through artificial neurons (i.e., nodes) forming a network through synaptic connections where a strength of the synaptic connections is changed through training. A neuron of the neural network may include a combination of weights or biases. The neural network may include one or more of layers, each including one or more of neurons or nodes. The neural network may infer a result from a predetermined input by changing weights of the neurons through training.

The neural network may include architectures including a deep neural network (DNN), a convolutional neural network (CNN), a recurrent neural network (RNN), a perceptron, a multilayer perceptron, a feed forward (FF), a radial basis network (RBF), a deep feed forward (DFF), a long short-term memory (LSTM), a gated recurrent unit (GRU), an autoencoder (AE), a variational autoencoder (VAE), a denoising autoencoder (DAE), a sparse autoencoder (SAE), a Markov chain (MC), a Hopfield network (HN), a Boltzmann machine (BM), a restricted Boltzmann machine (RBM), a deep belief network (DBN), a deep convolutional network (DCN), a deconvolutional network (DN), a deep convolutional inverse graphics network (DCIGN), a generative adversarial network (GAN), a liquid state machine (LSM), an extreme learning machine (ELM), an echo state network (ESN), a deep residual network (DRN), a differentiable neural computer (DNC), a neural turning machine (NTM), a capsule network (CN), a Kohonen network (KN), a binarized neural network (BNN), and an attention network (AN).

In some examples, the neural network operation apparatus 10 is applied to a neural network operation apparatus using a low-precision accumulator. For example, the neural network operation apparatus 10 may add a scaler or bit-selection process before an accumulator of partial sums, thereby improving performance of the accumulator and reducing power consumption or an area without compromising precision of an operation.

The neural network operation apparatus 10 may optimize a number of bits at which a scale value or data used to perform a scaling operation is truncated. The neural network operation apparatus 10 may input a most significant bit of truncated bits as a carry-in and remove a statistical bias generated by discarding low bits of a partial sum. The neural network operation apparatus 10 may not fix, but instead may actively selects the number of bits to be truncated in the partial sum such that various neural networks or data sets may dynamically respond.

The neural network operation apparatus 10 may be implemented in device such as a personal computer (PC), a data server, or a portable device. The device may be implemented as a laptop computer, a mobile phone, a smartphone, a tablet PC, a mobile internet device (MID), a personal digital assistant (PDA), an enterprise digital assistant (EDA), a digital still camera, a digital video camera, a portable multimedia player (PMP), a personal navigation device or portable navigation device (PND), a handheld game console, an e-book, or a smart device. The smart device may be implemented as a smart watch, a smart band, or a smart ring.

The neural network operation apparatus 10 may include a receiver 100 and a processor 200. The neural network operation apparatus 10 may further include a memory 300.

The receiver 100 may include a receiving interface. The receiver 100 may receive data for a neural network operation via the receiving interface. The data for the neural network operation may include model parameters (e.g., weights) of the neural network or operand data of the neural network operation. The receiver 100 may output data to the processor 200.

The processor 200 may process data stored in the memory 300. The processor 200 may execute computer-readable code (e.g., software) and executable instructions stored in the memory 300.

The processor 200 may be a hardware-implemented data processing apparatus having a circuit that is physically structured to execute target operations. The target operations may include, for example, code or instructions included in a program.

For example, the hardware-implemented data processing apparatus may include a microprocessor, a CPU, a processor core, a multi-core processor, a multiprocessor, an ASIC, and an FPGA.

The processor 200 may perform a scaling operation by multiplying data by a constant. The processor 200 may calculate a partial sum based on the data. The processor 200 may perform the scaling operation on the partial sum. A partial sum may be a sum of a subset of the input data. In some examples, the partial sum is calculated by adding up the subset of the input data. The processor 200 may perform the scaling operation on this partial sum. In some examples, a scaled partial sum of a first subset of the input data may be added to a scaled partial sum of a second subset of the input data. In some examples, processor 200 multiplies the partial sums with the same constant value. By performing a scaling operation on the partial sums, the number of calculations needed for processor 200 to scale the entire input data is reduced.

The processor 200 may perform the scaling operation based on a scale factor. In one example, the scale factor for the processor 200 may be a power of two. The processor 200 may determine the scale factor based on the precision of the accumulator. For example, if the accumulator has a precision of 16 bits, the scale factor may be chosen so that the scaled data does not exceed the maximum or minimum representable value in the accumulator.

The processor 200 may perform a rounding operation by truncating bits forming a result of scaling operation.

The processor 200 may perform the rounding operation by performing truncation based on a most significant bit of the result of the scaling operation. The processor 200 may perform the rounding operation by inputting the most significant bit to the accumulator.

The processor 200 may perform a bit-selection operation that involves selecting one of a first scale value and a second scale value based on a selection bit. The processor 200 may determine the selection bit based on a type of a neural network.

The processor 200 may perform the scaling back operation based on a result of the rounding operation. In some examples, the neural network operation apparatus 10 includes a non-transitory memory that stores data generated during the neural network operations. In some examples, the processor 200 performs the scaling operation, the rounding operation, and the scaling back operation and generates data as a result of the operations. The generated data is stored in the non-transitory memory. For example, the generated data may be stored in an accumulator.

The processor 200 may perform a clipping operation on the result of the rounding operation based on a predetermined precision range. Clipping is a process in which the values of data are limited or restricted to a predetermined range or precision. Clipping may be used in neural network operations to prevent the values of the data from getting too large or too small, thereby reducing numerical instability or overflow. In some examples, processor 200 performs a clipping operation on the result of the rounding operation based on a predetermined precision range. In some examples, processor 200 limits the precision of the data to a range by limiting the values of the data that exceed this range.

The processor 200 may perform the scaling back operation on a result of the clipping operation.

The processor 200 may generate a neural network operation result by accumulating results of the scaling back operation.

The scaling operation and the scaling back operation may be performed by a bit shifter.

The memory 300 may store data for an operation or an operation result. The memory 300 may store instructions (or programs) executable by the processor 200. For example, the instructions may include instructions for executing an operation of the processor and/or instructions for executing an operation of a component of the processor.

The memory 300 may be implemented as a volatile memory device or a non-volatile memory device.

The volatile memory device may be implemented as a dynamic random-access memory (DRAM), a static random-access memory (SRAM), a thyristor RAM (T-RAM), a zero capacitor RAM (Z-RAM), or a twin transistor RAM (TTRAM).

The non-volatile memory device may be implemented using an electrically erasable programmable read-only memory (EEPROM), a flash memory, a magnetic RAM (MRAM), a spin-transfer torque (STT)-MRAM, a conductive bridging RAM (CBRAM), a ferroelectric RAM (FeRAM), a phase change RAM (PRAM), a resistive RAM (RRAM), a nanotube RRAM, a polymer RAM (PoRAM), a nano floating gate Memory (NFGM), a holographic memory, a molecular electronic memory device, or an insulator resistance change memory.

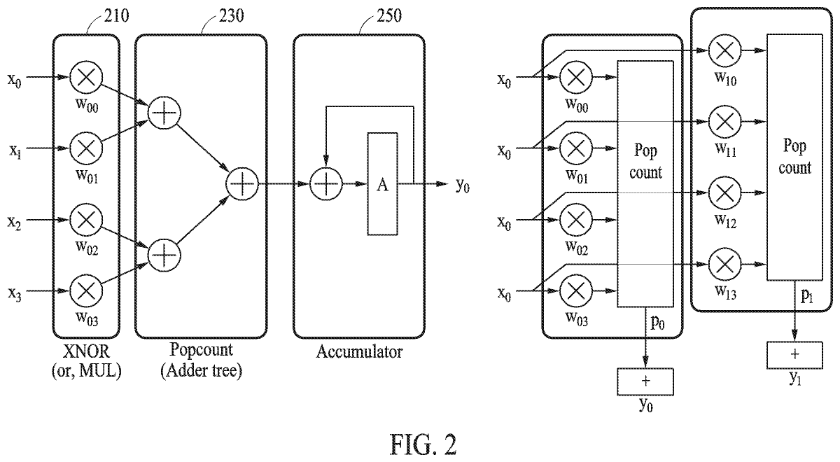

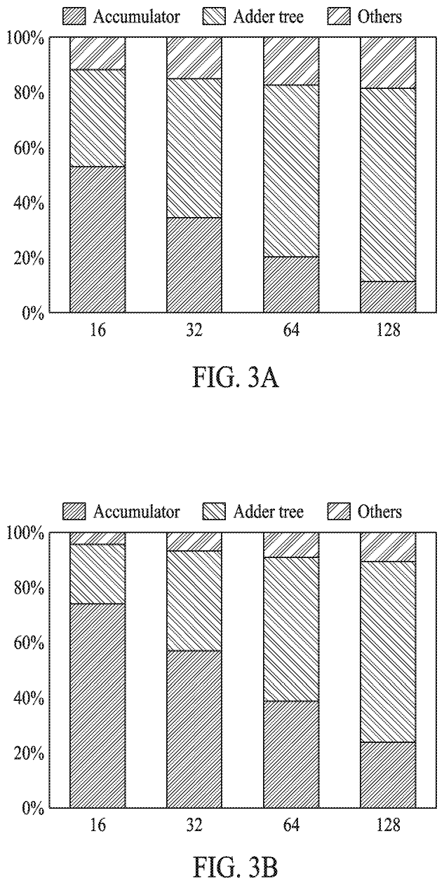

FIG. 2 illustrates an example of an implementation of a neural processing unit (NPU) structure, FIG. 3A illustrates a change in area of a MAC array depending on a tile size, and FIG. 3B illustrates a change in power consumption of a MAC array depending on a tile size.

Referring to FIGS. 2 through 3B, a processor (e.g., the processor 200 of FIG. 1) may include a MAC array. The MAC array may include an XNOR (or exclusive NOR) element 210, a popcount element 230, and an accumulator 250. The XNOR element 210 may be implemented as a multiplier (MUL), and the popcount element 230 may be implemented as an adder tree. An adder tree may be a type of digital circuit used for fast arithmetic operations, such as addition or multiplication. The popcount element 230 may be implemented as an adder tree to perform accumulate operations on partial sums.

FIGS. 3A and 3B illustrate an area and power consumption, respectively, of a BNN data path including the XNOR element 210, the popcount element 230, and the accumulator 250 of FIG. 2. As illustrated in FIGS. 3A and 3B, as operation bits increase, an area occupied by the adder tree and power consumption may increase.

An amount of computation and power consumption of BNN hardware may be dominantly determined by addition. An accumulate operation may occupy a large portion of hardware overhead. The accumulate operation may be effectively reduced by using a reduced width accumulator. However, determining an optimal accumulator width may be difficult due to a complex interaction between a width, scale, and training effect.

The tile size may be a number of input elements that may be simultaneously processed by hardware. The tile size may affect a number of XNOR elements 210 and a size and height of the adder tree for a popcount function. The popcount function may be a hardware operation that counts the number of bits set to 1 in a binary sequence. The number of XNOR elements 210 may be the number of logic gates that perform XNOR operation in the MAC array of a neural processing unit (NPU) structure. As illustrated in FIGS. 3A and 3B, an area and an amount of power consumed by the accumulator 250 have a 64-bit tile size, and may occupy 20% of the area and 40% of the power consumption, respectively.

The processor 200 may determine a size of the accumulator 250 while minimizing an influence on quality of a neural network operation result. The processor 200 may perform a neural network operation at a low cost using an algorithm based on a quantization technique.

In some examples, the processor 200 reduces an area and an amount of power required for the neural network operation using a top-down approach and a bottom-up approach.

In some examples, the processor 200 minimizes the size of the accumulator using partial sum scaling with a top-down approach. The processor 200 may implement an operation apparatus robust against an overflow using a saturation accumulator with the bottom-up approach.

The processor 200 may maintain precision of the neural network operation at low accumulator precision while maintaining hardware integrity and preserving throughput and area.

A neural network operation apparatus (e.g., the neural network operation apparatus 10 of FIG. 1) may be implemented as hardware that uses the top-down approach and partial sum scaling that minimize the size of the accumulator 250.

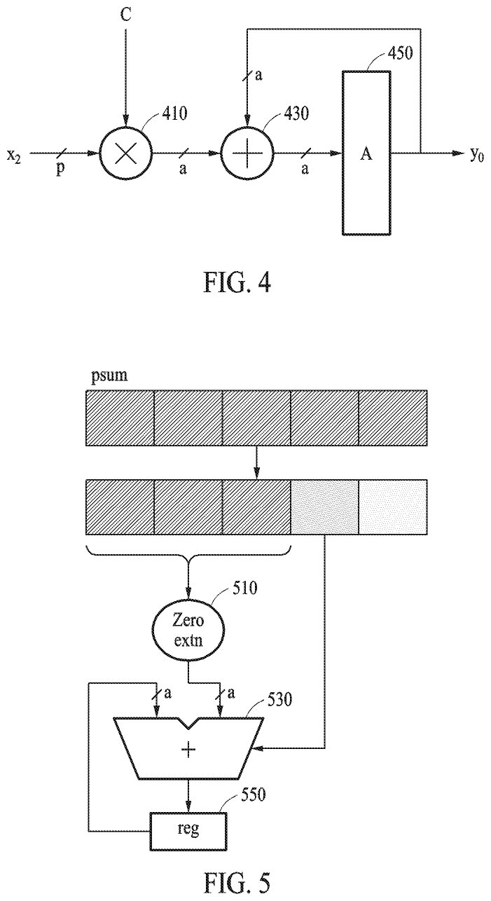

FIG. 4 illustrates an example of an implementation of a neural network operation apparatus. The neural network operation may be a neural network operation illustrated in FIG. 1.

Referring to FIG. 4, a processor (e.g., the processor 200 of FIG. 1) may include a multiplier 410, an adder 430, and an accumulator 450.

P may denote a partial sum of data for a neural network operation. P may be provided from the multiplier or an output of a multiplier tree. C may denote a scaling constant for the neural network operation, where the constant is multiplied before partial sums are accumulated.

The processor 200 may perform a scaling operation on a partial sum based on the constant C.

The processor 200 may perform a scaling operation by multiplying data by a constant. The processor 200 may calculate a partial sum based on the data. The processor 200 may perform the scaling operation on the partial sum.

The processor 200 may perform the scaling operation based on a scale factor. In the processor 200, the scale factor may be a power of two. The processor 200 may determine the scale factor based on precision of the accumulator. The precision of an accumulator may be the number of bits used to represent the data in the accumulator. The processor 200 may perform a clipping operation on the result of a rounding operation based on a predetermined precision range. The processor 200 may perform the scaling back operation on a result of the clipping operation.

The processor 200 may perform quantization on the partial sum. The processor 200 may perform quantization on the partial sum using a scaling operation, a rounding operation, a clipping operation, and a scaling back operation. In some examples, a quantization operation comprises reducing the precision of a number by limiting the number of bits used to represent it. In some examples, performing a quantization operation comprises representing the weights and activations of the neural network using a smaller number of bits, reducing the memory and computation required for the network. The scaling operation may be performed by dividing A, and the scaling back operation may be performed by multiplying by A. The processor 200 may perform the scaling operation, the rounding operation, the clipping operation, and the scaling back operation without an additional logic circuit that causes hardware overhead such as floating-point multiplication.

The processor 200 may perform the scaling operation, the rounding operation, and the clipping operation on the partial sum using Equation 1.

$$\overline{p} = clip ( ⌊ \frac{p}{Δ} ⌉ ; 0 , {2}^{a} - 1 ) \qquad [ Equation 1 ]$$

A neural network used by the processor 200 may be pre-processed so that the neural network is binarized. In some examples, the weights and activations of the neural network is converted to binary values, such as −1 and +1. Data to be input to a quantization function and a partial sum may be an integer having a finite range. In Equation 1, a partial sum p may satisfy 0≤p≤T, and T may denote a tile size.

A clipping operation may be defined as clip(x;a,b)=min(max(x,a),b). └•┐ may denote a rounding operation. Δ may denote a quantization parameter that is referred to as a scale factor. A may denote precision of an accumulator.

The processor 200 may perform a scaling back operation based on a result of the rounding operation. The processor 200 may perform the scaling back operation using Equation 2.

\hat{p}=p̅·Δ[Equation 2]

FIG. 5 illustrates an operation of a scaling accumulator including a rounding operation.

Referring to FIG. 5, a processor (e.g., the processor 200 of FIG. 1) may include a zero extender 510, an adder 530, and a register 550. The zero extender 510 may add zero to a truncated partial sum.

The adder 530 may perform an operation of two pieces of data based on a carry-in bit. The register 550 may accumulate and store addition results.

The processor 200 may perform a scaling operation by multiplying data by a scaling constant. The processor 200 may calculate a partial sum based on the data. The processor 200 may perform the scaling operation on the partial sum.

The processor 200 may perform the scaling operation based on a scale factor. In the processor 200, the scale factor may be a power of two. The processor 200 may determine the scale factor based on precision of the accumulator.

The processor 200 may replace a multiplication operation with a bit shift operation using a value that is a power of two as a scale factor. The processor 200 may apply a same scale factor to a plurality of layers included in a neural network.

The processor 200 may determine a scale factor based on a tile size. In some cases, a tile size may be determined by hardware that performs a neural network operation. For example, the tile size may be the number of input elements, for example, individual data points, that can be simultaneously processed by the hardware. According to some embodiments, a tile size is a hardware-dependent hyperparameter. An accumulator may be optimized based on the hyperparameters including the tile size. The processor 200 may use a bit-selection operation and remove the bit shift operation by hard-coding the scale factor. In this case, a logic gate may not be required.

When a denotes accumulator precision and b denotes effective partial sum precision. the accumulator precision and the effective partial sum precision are technically identical. In some cases, the processor 200 uses a power of two as the scale factor, and thus, some bits (e.g., c bit) may not be included in the partial sum, where the accumulator precision and the effective partial sum precision are not identical. For example, the processor 200 may use b=a−c as the effective partial sum precision.

When b is determined, the processor 200 may calculate the scale factor using Equation 3.

$$Δ = \frac{T}{{2}^{b} - 1} \approx \frac{T}{{2}^{b}} \qquad [ Equation 3 ]$$

The tile size T may be a power of two (e.g., 32, 64, 128, . . . ). Therefore, since the scale factor Δ is a power of two, a scaling operation may not depend on a separate multiplier.

Scale factors of all layers of the neural network may be a power of two. Accordingly, as in a case of using an FPGA accelerator, the processor 200 may perform scaling and a scaling back operations without consuming an additional logic gate for any network.

A bit shifter may be used to support a plurality of different neural network models with a partial sum precision value. As a scaling back operation is combined with input quantization of a subsequent layer and processed, additional hardware may not be required.

The processor 200 may perform a rounding operation by truncating bits forming a result of a scaling operation.

The processor 200 may perform the rounding operation by performing truncation based on a most significant bit of the result of the scaling operation. The processor 200 may perform the rounding operation by inputting the most significant bit to the accumulator.

In quantization, the rounding operation may require an adder that generally increases hardware overhead. However, the processor 200 may perform the rounding operation without an adder by simply truncating an input and inputting a most significant bit of a truncated bit as a carry-in bit of the accumulator. Adding the carry-in bit may change a rounding down operation to a rounding off operation.

The example of FIG. 5 may be an example of a 5-bit partial sum and a scale parameter of 4. The processor 200 may perform the rounding operation without an additional adder by truncating last two bits and inputting one of the two bits to the accumulator.

The processor 200 may perform a scaling back operation based on a result of the rounding operation.

The processor 200 may perform a clipping operation on the result of a rounding operation based on a predetermined precision range. The processor 200 may perform the scaling back operation on a result of the clipping operation.

The processor 200 may avoid using bits exceeding allowed bits by performing the clipping operation. A random value may be used as a scale factor during training. The processor 200 may not perform the clipping operation when an expression falls within a range of accumulator precision during inference. In a partial sum scaling operation, a scale factor may be determined by partial sum precision and may always be greater than 1. Therefore, the clipping operation may be safely excluded.

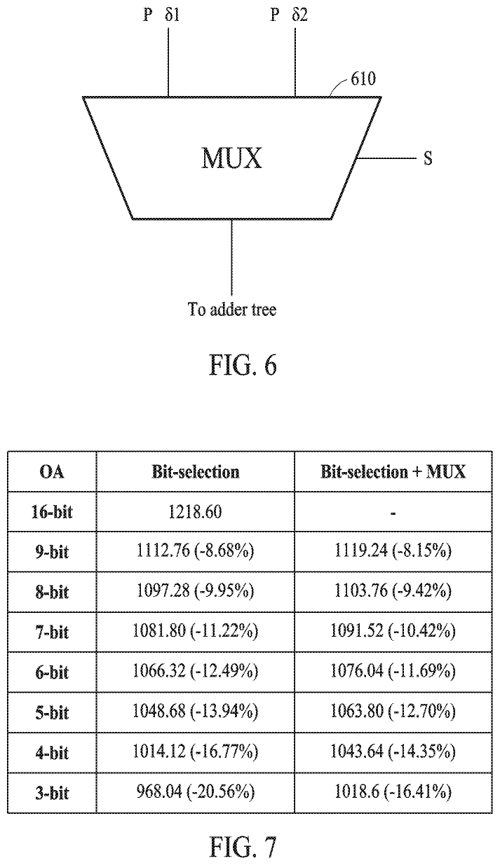

FIG. 6 illustrates a multiplexer for supporting a plurality of scale parameters, and FIG. 7 illustrates a comparison of areas according to whether there is a multiplexer.

Referring to FIGS. 6 and 7, a processor (e.g., the processor 200 of FIG. 1) may perform a bit-selection operation that involves selecting one of a first scale value and a second scale value based on a selection bit. The processor 200 may determine the selection bit based on a type of a neural network. For example, a first scale value may be selected based on the type of the neural network is CNN, and a second scale value may be selected based on the type of the neural network is RNN.

The processor 200 may further include a multiplexer 610 for supporting a plurality of scale parameters. The multiplexer 610 may select one of the first scale value and the second scale value based on a selection bit S.

In some examples, layers of a same neural network may share a same scale parameter. In some examples, different neural networks may use different scale parameters for optimal performance, therefore different scale parameters may be used depending on a type of a neural network. Different scale parameters used for different neural networks may be similar to or different from each other.

The processor 200 may determine a scaling factor based on a acombination of partial sum precision and accumulate operation precision for different neural networks that have a different number of layers and channels. For example, the processor 200 may determine a combination of partial sum precision and accumulate operation precision of a residual network (ResNet)-18 binary network and a visual geometry group (VGG) binary network.

In some examples, for the ResNet-18 binary neural network and the VGG binary network, the ResNet-18 binary neural network may have the smallest number of channels and the VGG binary network may have the largest number of channels. Different neural networks have different optimal partial sum precisions. In some cases, the difference less than 1 bit. This is described in detail with reference to FIGS. 14 and 16.

I some cases, the partial sum precision of an entire binary neural network may be one of the two values. In some examples, the processor 200 may select a scale value by adding the multiplexer 610 to a neural network operation apparatus. The scale value may include the first scale value δ1 and the second scale value δ2. The first scale value and the second scale value may be constants. In some examples, the first scale value and the second scale value are different constants.

The processor 200 may select the scale value by performing a bit-selection operation using the multiplexer 610. The processor 200 may allow the multiplexer 610 to select one of P>>δ1 and P>>δ2. For example, the processor 200 may allow the multiplexer 610 to select one of P>>δ1 and P>>δ2 by hard coding the two scale values without using a barrel shifter or an additional logic gate. Hard coding comprises directly embedding a fixed value or instruction into the software or hardware code, rather than using a variable or parameter that can be changed during execution. Here, P may denote a partial sum input.

As illustrated in FIG. 7, comparing areas when the multiplexer 610 is added, a hardware area increases by about 0.5 to 4% when a bit-selection operation and the multiplexer 610 are used, incurring a relatively low cost.

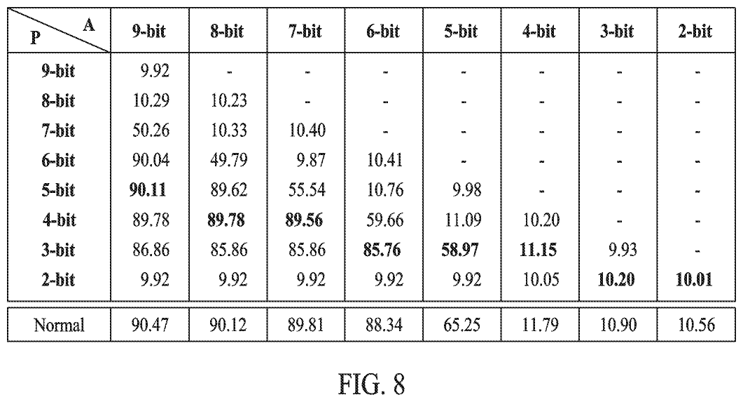

Hereinafter, test results obtained using the neural network operation apparatus of FIG. 1 are described with reference to FIGS. 8 through 14.

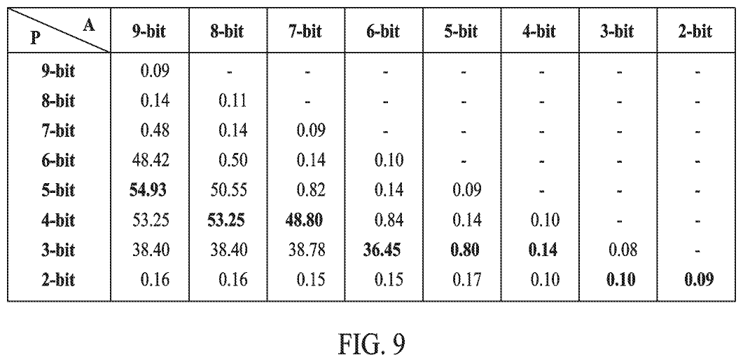

FIG. 8 illustrates an example of a post-training quantization (PTQ) result, and FIG. 9 illustrates another example of a PTQ result.

Referring to FIGS. 8 and 9, two BNNs may be used in a test. The two BNNs may be Bi-Real Net 18 of ImageNet and BinaryNet of CIFAR-10. The BinaryNet of CIFAR-10 may be a binary version of ResNet-18.

In some examples, a tile size is fixed to T=64, and partial sum scaling is not used for the first layer and the last layer of the neural network. Test results of a neural network operation apparatus (e.g., the neural network operation apparatus 10 of FIG. 1) may be compared with a baseline design using a 16-bit accumulator.

Post-training quantization (PTQ) may be performed to determine a partial sum precision. In some examples, PTO is performed to determine a partial sum precision by searching for a target combination of partial sum precision and accumulate operation precision. In a PTQ setting, a combination of partial sum precision and accumulate operation precision may be searched for through an exhaustive search. The partial sum precision may not exceed the accumulate operation precision.

A scale factor may be calculated using Equation 3 above, where b may denote the partial sum precision. FIG. 8 demonstrates a result of CIFAR-10, and FIG. 9 demonstrates a result of ImageNet. A partial sum-accumulate operation precision may be determined by highest performance of a neural network. For example, a combination for a 9-bit accumulator may be a partial sum precision of 5 bits.

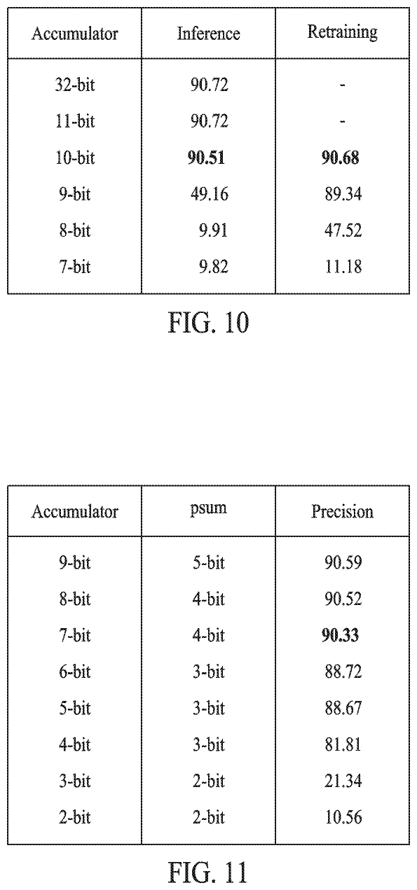

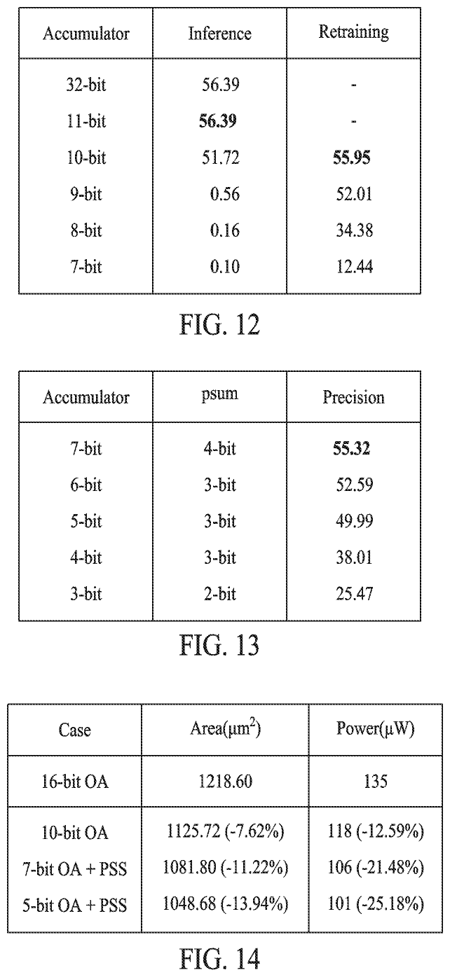

FIG. 10 illustrates an example of precision of an accumulator without a scaler, and FIG. 11 illustrates an example of precision of an accumulator with a scaler. FIG. 12 illustrates another example of precision of an accumulator without a scaler, FIG. 13 illustrates another example of precision of an accumulator when with a scaler, and FIG. 14 illustrates an area and power consumption when the neural network operation apparatus of FIG. 1 is used.

Referring to FIGS. 10 through 14, a neural network may be retrained using quantization-aware training (QAT) after an effective partial sum precision b is determined.

FIGS. 10 through 13 demonstrate results obtained after the retraining. FIGS. 10 and 11 demonstrate results for Binary ResNet-18 of CIFAR-10 having different accumulate operation precision values. A baseline of the examples of FIGS. 10 and 11 may be 90.72%.

FIGS. 12 and 13 demonstrate results for Bi-Real Net 18 of ImageNet having different accumulate operation precision values. A baseline of the examples of FIGS. 12 and 13 may be 56.39%.

For Binary ResNet-18 of CIFAR 10 having different accumulate operation precision values, performance of a 7-bit accumulator may be degraded by, for example, 0.5% compared to the baseline. A general adder may not operate properly in an extreme low-cost accumulator (e.g., a 2-bit or 3-bit accumulator), but a neural network operation apparatus (e.g., the neural network operation apparatus 10 of FIG. 1) may operate without substantial decrease in performance.

For Bi-Real Net 18 of ImageNet, performance of the 7-bit accumulator may be similar to the baseline.

A 64*64 array binary data path may be used to evaluate hardware efficiency when the neural network operation apparatus 10 is used. The 64*64 array binary data path has 64 inputs and 64 outputs, and thus, 4096 XNOR elements and 64 adder trees may be needed followed by accumulators. FIG. 14 illustrates the area and power consumption of the 64*64 array operator when the neural network operation apparatus 10 is applied. In FIG. 16, PSS may stand for partial sum scaling. A baseline may be 16-bit OA (Our Architecture).

As illustrated in FIG. 16, applying the neural network operation apparatus 10 may reduce power consumption and an area by 21.48% and 11.22%, respectively, in a 7-bit OA that performs partial sum scaling.

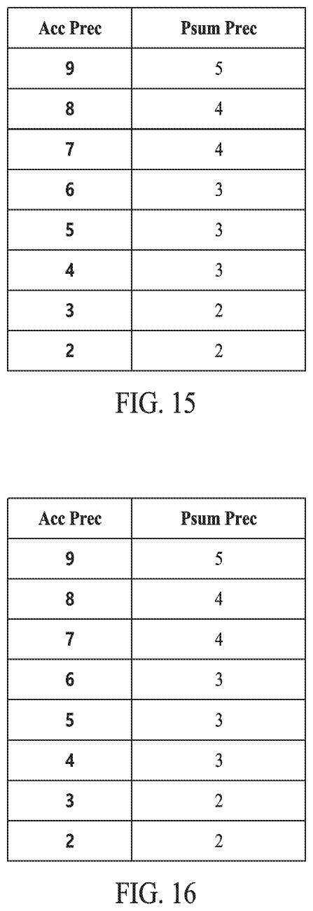

FIG. 15 illustrates an example of partial sum operation precision according to accumulate operation precision, and FIG. 16 illustrates another example of partial sum operation precision according to accumulate operation precision.

Referring to FIGS. 15 and 16, different scale parameters may be used for different neural networks. FIG. 15 demonstrates an example of partial sum precision according to accumulate operation precision of a ResNet-18 binary network, and FIG. 16 demonstrates an example of partial sum precision according to accumulate operation precision of a VGG binary network.

As illustrated in FIGS. 6 and 7, a processor (e.g., the processor 200 of FIG. 1) may determine combinations of partial sum precision and accumulate operation precision of a residual network (ResNet)-18 binary network and a VGG binary network.

Of the ResNet-18 binary neural network and the VGG binary network, the ResNet-18 binary neural network may have a smallest number of channels and the VGG binary network may have the largest number of channels. In some examples, different neural networks may have different partial sum precision values, with a difference between the values being less than 1 bit.

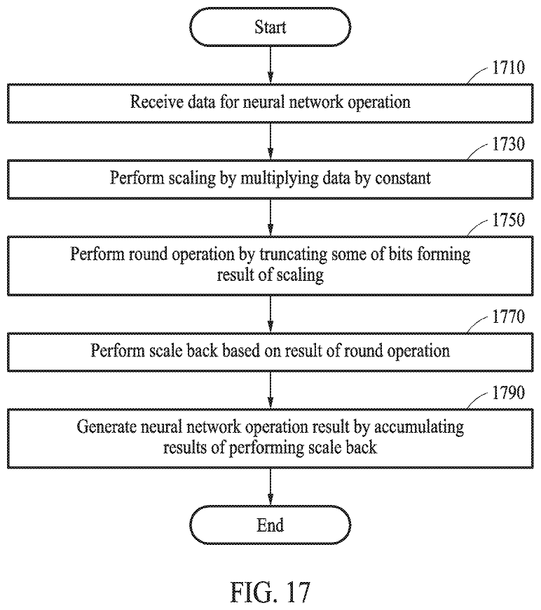

FIG. 17 is a flowchart of an operation of the neural network operation apparatus illustrated in FIG. 1. Referring to FIG. 17, in operation 1710, a receiver (e.g., the receiver 100 of FIG. 1) may receive data for a neural network operation. FIG. 17 provides an example of the operation of the neural network operation apparatus, but the operation of the neural network operation apparatus is not limited thereto and may perform other operations in addition to or as an alternative to the operations described in FIG. 17.

At operation 1730, a processor (e.g., the processor 200 of FIG. 1) performs a scaling operation by multiplying the data by a constant. The processor 200 may calculate a partial sum based on the data. The processor 200 may perform the scaling operation on the partial sum. In some cases, the processor 200 may perform the scaling operation based on a scale factor. In the processor 200, the scale factor may be a power of two. The processor 200 may determine the scale factor based on precision of an accumulator.

At operation 1750, the processor 200 performs a rounding operation by truncating bits forming a result of the scaling operation. In some cases, the processor 200 may perform the rounding operation by performing truncation based on a most significant bit of the result of the scaling operation. The processor 200 may perform the rounding operation by inputting the most significant bit to the accumulator. The processor 200 may perform a bit-selection operation that involves selecting one of a first scale value and a second scale value based on a selection bit. The processor 200 may determine the selection bit based on a type of a neural network.

At operation 1770, the processor 200 performs a scaling back operation based on a result of the rounding operation. In some cases, the processor 200 may perform a clipping operation on the result of the rounding operation based on a predetermined precision range. The processor 200 may perform the scaling back operation on a result of the clipping operation.

At operation 1790, the processor 200 may generate a neural network operation result by accumulating results of the scaling back operation.

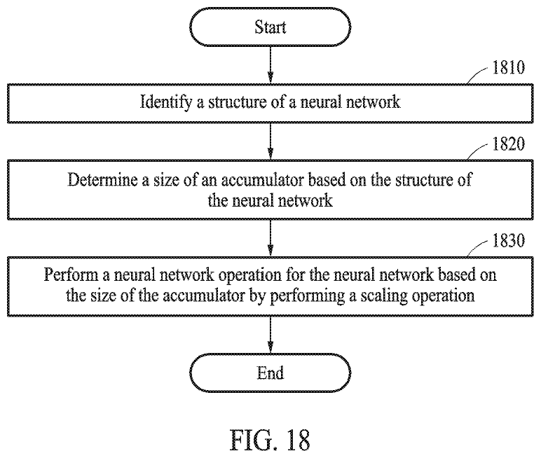

FIG. 18 is a flowchart illustrating a method of performing a neural network operation. In some examples, these operations are performed by a system, such as neural network operation apparatus 10, including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 1810, the system may identify a structure of a neural network. For example, the structure may include the architecture, parameters, or hyperparameters of the neural network. The structure of the neural network may influence the optimal size of an accumulator for performing neural network operations for the neural network.

At operation 1820, the system may determine a size of an accumulator based on the structure of the neural network. For example, the system may perform an optimization operation to determine the size of the accumulator.

In one embodiment, the size of the accumulator is initialized to a predetermined value (e.g., a small value such as 2 bits). Then a size of a partial sum (psum) may be determined based on the accumulator size. For example, the accumulator size may be determined based on a table such as the following relationship between psum size, accumulator size, and performance:

TABLE 1
PTQ for P (partial sum) and A (accumulator)

| | A | | | | | | | |
|---|---|---|---|---|---|---|---|---|
| P | 9-bit | 8-bit | 7-bit | 6-bit | 5-bit | 4-bit | 3-bit | 2-bit |
| 9-bit | 9.92 | — | — | — | — | — | — | — |
| 8-bit | 10.29 | 10.23 | — | — | — | — | — | — |
| 7-bit | 50.26 | 10.33 | 10.40 | — | — | — | — | — |
| 6-bit | 90.04 | 49.79 | 9.87 | 10.41 | — | — | — | — |
| 5-bit | 90.11 | 89.62 | 55.54 | 10.76 | 9.98 | — | — | — |
| 4-bit | 89.78 | 89.78 | 89.56 | 59.66 | 11.09 | 10.20 | — | — |
| 3-bit | 86.86 | 85.86 | 85.86 | 85.76 | 58.97 | 11.15 | 9.93 | — |
| 2-bit | 9.92 | 9.92 | 9.92 | 9.92 | 9.92 | 10.05 | 10.20 | 10.01 |
| General | 90.47 | 90.12 | 89.81 | 88.34 | 65.25 | 11.79 | 10.90 | 10.56 |

Accordingly, a scale factor may be determined using post-training quantization (PTQ) for one or more psum sizes. A psum size that results in a target performance (e.g., a target recognition rate) may be selected. For example, if the accumulator size is 7 bits the psum may be set to 4 bits. In some examples, the PTQ changes the scale factor but does not change the neural network weights.

In some examples, the selected accumulator size and the corresponding psum size may be used to further improve performance of the neural network while learning neural network weights. If the performance is satisfactory, the accumulator size may be set. Otherwise, the process may be repeated until a satisfactory accumulator size is identified.

At operation 1830, the system performs a neural network operation for the neural network based on the size of the accumulator by performing a scaling operation. For example, the system may perform the operations described in FIG. 17 to perform the scaling operation.

Embodiments of the present disclosure may be implemented using a hardware component, a software component and/or a combination thereof. A processing device may be implemented using one or more of general-purpose or special-purpose computers, such as a processor, a controller and an arithmetic logic unit (ALU), a digital signal processor (DSP), a microcomputer, an FPGA, a programmable logic unit (PLU), a microprocessor or any other device capable of responding to and executing instructions in a defined manner. The processing device may run an operating system (OS) and one or more of software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and multiple types of processing elements. For example, the processing device may include a plurality of processors, or a single processor and a single controller. In addition, different processing configurations are possible, such as parallel processors.

Software may include a computer program, a piece of code, an instruction, or some combination thereof, to independently or collectively instruct or configure the processing device to operate as targeted. Software and/or data may be embodied permanently or temporarily in any type of machine, component, physical or virtual equipment, computer storage medium or device, or in a propagated signal wave capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to embodiments of the present disclosure may be recorded in non-transitory computer-readable media including program instructions to implement various operations of the above-described examples. The media may also include, alone or in combination with the program instructions, data files, data structures, and the like. The program instructions recorded on the media may be those specially designed and constructed for the purposes of examples, or they may be of the kind well-known and available to those having skill in the computer software arts. Examples of non-transitory computer-readable media include magnetic media such as hard disks, floppy disks, and magnetic tape; optical media such as CD-ROM discs and DVDs; magneto-optical media such as optical discs; and hardware devices that are specially configured to store and perform program instructions, such as ROM, RAM, flash memory, and the like. Examples of program instructions include both machine code, such as produced by a compiler, and files containing higher-level code that may be executed by the computer using an interpreter.

The hardware devices according to embodiments of the present disclosure may be configured to act as one or more software modules in order to perform the operations of the above-described examples, or vice versa.

Embodiments of the present disclosure are not limited to the examples that have been described with reference to the drawings, and one of ordinary skill in the art may apply various technical modifications and variations based thereon. For example, suitable results may be achieved if the described techniques are performed in a different order and/or if components in a described system, architecture, device, or circuit are combined in a different manner, and/or replaced or supplemented by other components or their equivalents.

Terms, such as first, second, and the like, may be used herein to describe various components. Each of these terms is not used to define an essence, order or sequence of a corresponding component but is used merely to distinguish the corresponding component from other component(s). For example, a first component may be referred to as a second component, and similarly the second component may be referred to as the first component.

It should be noted that if it is described that one component is “connected,” “coupled,” or “joined” to another component, a third component may be “connected,” “coupled,” and “joined” between the first and second components, although the first component may be directly connected, coupled, or joined to the second component.

The singular forms “a,” “an,” and “the” are intended to include the plural forms as well, unless the context clearly indicates otherwise. As used herein, “A or B”, “at least one of A and B”, “at least one of A or B”, “A, B or C”, “at least one of A, B and C”, and “at least one of A, B, or C,” each of which may include any one of the items listed together in the corresponding one of the phrases, or all possible combinations thereof. It will be further understood that the terms “comprises/comprising” and/or “includes/including” when used herein, specify the presence of stated features, integers, steps, operations, elements, and/or components, but do not preclude the presence or addition of one or more of other features, integers, steps, operations, elements, components and/or groups thereof.

Unless otherwise defined, all terms, including technical and scientific terms, used herein have the same meaning as commonly understood by one of ordinary skill in the art to which this disclosure pertains. Terms, such as those defined in commonly used dictionaries, should be construed to have meanings matching with contextual meanings in the relevant art and the present disclosure, and are not to be construed as having an ideal or excessively formal meaning unless otherwise defined herein.

As used in connection with the present disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more of functions. For example, the module may be implemented in a form of an application-specific integrated circuit (ASIC).

The term “unit” or the like used herein may refer to a software or hardware component, such as a field-programmable gate array (FPGA) or an ASIC, and the “unit” performs predefined functions. However, “unit” is not limited to software or hardware. The “unit” may be configured to reside on an addressable storage medium or configured to operate one or more of processors. Accordingly, the “unit” may include, for example, components, such as software components, object-oriented software components, class components, and task components, processes, functions, attributes, procedures, sub-routines, segments of program code, drivers, firmware, microcode, circuitry, data, databases, data structures, tables, arrays, and variables. The functionalities provided in the components and “units” may be combined into fewer components and “units” or may be further separated into additional components and “units.” Furthermore, the components and “units” may be implemented to operate on one or more of central processing units (CPUs) within a device or a security multimedia card. In addition, “unit” may include one or more of processors.

Hereinafter, the examples will be described in detail with reference to the accompanying drawings. In the descriptions of the examples referring to the accompanying drawings, like reference numerals refer to like elements and any repeated description related thereto has been omitted.

Therefore, the scope of the disclosure is defined not by the detailed description, but by the claims and their equivalents, and all variations within the scope of the claims and their equivalents are to be construed as being included in the disclosure.

What is claimed is:

1. A neural network operation apparatus comprising:
a receiver configured to receive data for a neural network operation of a neural network; and
a processor configured to:
determine a scaling constant based on a structure of the neural network;
perform a scaling operation by multiplying the data by the scaling constant to obtain scaled data;
perform a rounding operation by truncating bits forming a result of the scaling operation;
perform a scaling back operation based on a result of the rounding operation; and
perform the neural network operation by accumulating results of the scaling back operation.

2. The neural network operation apparatus of claim 1, wherein the processor is configured to:
perform a clipping operation on the result of the rounding operation based on a predetermined precision range; and
perform the scaling back operation on a result of performing the clipping operation.

3. The neural network operation apparatus of claim 1, wherein the processor is configured to:
calculate a partial sum based on the data; and
perform the scaling operation on the partial sum.

4. The neural network operation apparatus of claim 1, wherein the scaling operation and the scaling back operation are performed by a bit shifter.

5. The neural network operation apparatus of claim 1, wherein:
the processor is configured to perform the scaling operation based on a scale factor that is a power of two.

6. The neural network operation apparatus of claim 5, wherein the processor is configured to determine the scale factor based on precision of an accumulator.

7. The neural network operation apparatus of claim 1, wherein the processor is configured to perform the rounding operation by performing truncation based on a most significant bit of the result of the scaling operation.

8. The neural network operation apparatus of claim 7, wherein the processor is configured to perform the rounding operation by inputting the most significant bit to an accumulator.

9. The neural network operation apparatus of claim 1, wherein the processor comprises a multiplexer configured to perform a bit-selection operation that involves selecting one of a first scale value and a second scale value based on a selection bit.

10. The neural network operation apparatus of claim 9, wherein the processor is configured to determine the selection bit based on a type of a neural network.

11. A neural network operation method comprising:
receiving data for a neural network operation of a neural network;
determining a scaling constant based on a structure of the neural network;
performing a scaling operation by multiplying the data by the scaling constant;
performing a rounding operation by truncating bits forming a result of the scaling operation,
performing a scaling back operation based on a result of the rounding operation, and
performing the neural network operation by accumulating results of the scaling back operation.

12. The neural network operation method of claim 11, wherein the performing the scaling back operation comprises:
performing a clipping operation on the result of the rounding operation based on a predetermined precision range; and
performing the scaling back operation on a result of the clipping operation.

13. The neural network operation method of claim 11, wherein the performing the scaling operation comprises:
calculating a partial sum based on the data; and
performing the scaling operation on the partial sum.

14. The neural network operation method of claim 11, wherein the scaling operation and the scaling back operation are performed by a bit shifter.

15. The neural network operation method of claim 11, wherein the scaling operation is based on a scale factor, and the scale factor is a power of two.

16. The neural network operation method of claim 15, wherein the performing the scaling operation comprises determining the scale factor based on precision of an accumulator.

17. The neural network operation method of claim 11, wherein the performing the rounding operation comprises performing the rounding operation by performing truncation based on a most significant bit of the result of the scaling operation.

18. The neural network operation method of claim 17, wherein the performing the rounding operation by performing the truncation based on the most significant bit of the result of the scaling operation comprises performing the rounding operation by inputting the most significant bit to an accumulator.

19. The neural network operation method of claim 11, further comprising:
performing a bit-selection operation that involves selecting one of a first scale value and a second scale value based on a selection bit.

20. The neural network operation method of claim 19, wherein the performing the bit-selection operation comprises determining the selection bit based on a type of the neural network.
